(19) United States
(12) Patent Application Publication
(10) Pub. No.: US 2023/0065275 A1
(43) Pub. Date: Mar. 2, 2023

(54) POLYMER COATED CONDUCTIVE RIBBON

(71) Applicant: 3M INNOVATIVE PROPERTIES COMPANY, St. Paul, MN (US)

(72) Inventors: Tianyu Wu, St. Paul, MN (US); Sean M. Sweetnam, Minneapolis, MN (US); Daniel M. Pierpont, North St. Paul, MN (US); Jiaying Ma, Cottage Grove, MN (US); Dong-Wei Zhu, North Oaks, MN (US); Nelson T. Rotto, Woodbury, MN (US)

(21) Appl. No.: 17/818,445

(22) Filed: Aug. 9, 2022

Related U.S. Application Data
(60) Provisional application No. 63/260,107, filed on Aug. 10, 2021.

(51) Int. Cl. C08K 9/06; C08K 3/013; H01B 3/44; H01B 7/02; H01B 7/17

(52) U.S. Cl. CPC C08K 9/06; C08K 3/013; H01B 3/441; H01B 7/0225; H01B 7/0275; H01B 7/17; C08K 2201/006; C08K 2201/011

(57) ABSTRACT

A polymer coated conductive ribbon is described herein, wherein the polymer coated conductive ribbon consists essentially of a smooth conductive member having a defined width and thickness substantially enclosed in an insulating polymeric sheath, wherein the insulating polymeric sheath comprises a thermoplastic insulating polymer as a first storage modulus (G′) is above 0.2 MPa at 40° C. and a second storage modulus below 0.05 MPa at 160° C.

### BACKGROUND OF THE INVENTION

### Field of the Invention

The present invention is directed to polymer coated conductive ribbons to electrically connect solar cells in a photovoltaic module. Specifically, the polymer coated ribbon is a smooth conductive ribbon having a defined width and thickness enclosed in an insulating polymeric sheath.

### Background

Conventional photovoltaic (PV) modules comprise a plurality of silicon solar cells which absorb light and generate electrical current. The electrical current is collected by fine silver fingers, usually screen printed, disposed on at least one of the first and second surfaces of the solar cell. Silver busbars interconnect the silver fingers. Typically, tin-lead coated copper ribbons are soldered onto Ag busbars to transfer electrical current out of the solar cells. However, the soldering processes used in the manufacture of photovoltaic modules is done at high temperature (˜220° C.). The high temperatures used in the soldering processes along with the coefficient of thermal expansion and modulus of the materials can induce stresses on silicon solar cells due to coefficient of thermal expansion mismatch between copper, solder and silicon (linear thermal expansion coefficient of copper is 16.8×10⁻⁶ K⁻¹; the linear thermal expansion coefficient of silicon is 2.4×10⁻⁶ K⁻¹). The induced thermal stresses can result in the cracking of the silicon cells, or imperfections in the solder joint over time and may ultimately lead to PV module failure.

Additionally, the high temperature soldering process has been identified as a barrier in silicon cell thickness reduction because thinner cells are more prone to cracking when under stress.

Various approaches have been proposed to replace high temperature soldering during the fabrication of solar modules with lower temperature interconnect means, such as the use of pressure sensitive adhesives (PSA) to mechanically hold conductive wires to solar cell surfaces. However, PSAs are inherently tacky and require liners in roll-to-roll handling and during storage at ambient temperatures. Because solar cells are very fragile, using a PSA may prevent rework during the PV module manufacturing process. Additionally, the moduli of PSAs are typically not high enough to withstand thermocycling between −40° C. to 85° C., the usable temperature range of solar cells.

There remains an unmatched need for a simple, elegant, and low cost solution for low temperature interconnection to replace soldering in the fabrication of photovoltaic modules.

### SUMMARY

In a first embodiment of the invention, a polymer coated conductive ribbon consists essentially of a smooth conductive member having a defined width and thickness substantially enclosed in an insulating polymeric sheath, wherein the insulating polymeric sheath comprises a thermoplastic insulating polymer with a first storage modulus (G′) is above 0.2 MPa at 40° C. and a second storage modulus below 0.05 MPa at 160° C.

In a first embodiment of the invention, a photovoltaic solar module comprises a plurality of solar cells disposed in an ordered array, wherein each solar cell comprises a silicon wafer having at least one first electrically conductive element formed on a front surface of the solar cell and at least one second electrically conductive element formed on a back surface of the solar cell; and at least one polymer coated conductive ribbon, wherein each polymer coated conductive ribbon consists essentially of a smooth conductive member having a defined width and thickness substantially enclosed in an insulating polymeric sheath, wherein the insulating polymeric sheath comprises a thermoplastic insulating polymer with a first storage modulus (G′) is above 0.2 MPa at 40° C. and a second storage modulus below 0.05 MPa at 160° C., electrically interconnecting at least one first electrically conductive element or second electrically conductive element of a first solar cell to at least one first electrically conductive element or second electrically conductive element of a second solar cell without the use of solder.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1A is schematic cross-section of a conventional photovoltaic module.

FIG. 1B is a schematic top view of a solar cell shown in the photovoltaic module of FIG. 1A.

FIGS. 2A and 2B are schematic cross-sections of an exemplary polymer coated conductive ribbon of the present invention shown before and after attachment to a front surface of a solar cell.

FIG. 3A is a schematic illustration of a shingled cell array unit wherein two adjacent cell slices are electrically interconnected by polymer coated conductive ribbon.

FIG. 3B is a schematic cross-section of the connection region between the two adjacent cell slices of FIG. 3A.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “forward,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

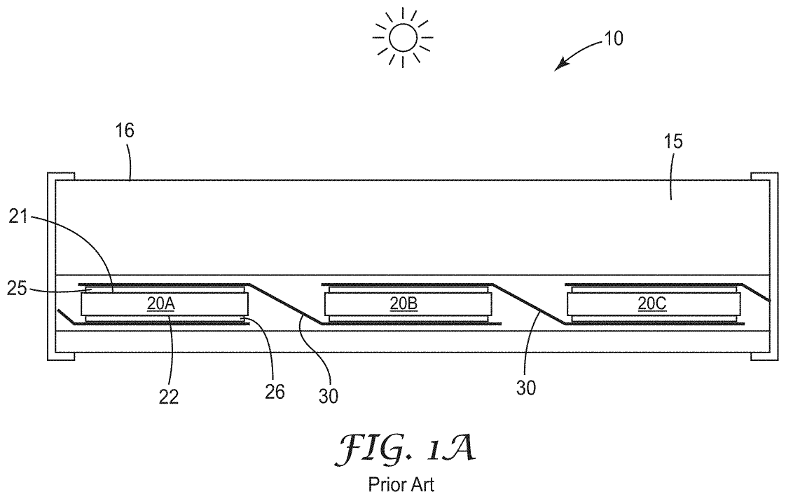

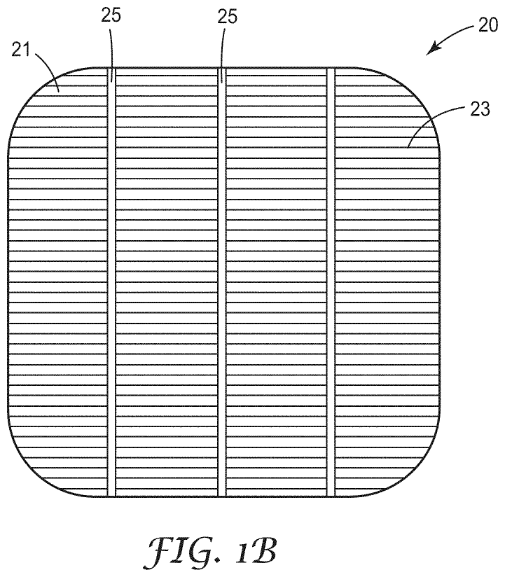

FIG. 1A shows a cross-section of photovoltaic module 10 taken along the length of one set of aligned busbars 25, 26 of the solar cells 20. Photovoltaic module 10, such as the one shown in FIG. 1A, convert energy emitted by the sun into electricity. Many conventional photovoltaic modules have a transparent top sheet 15 (e.g., a sheet of glass) on the sun facing side 16 of the module. Sunlight passes through the transparent top sheet and is incident on the solar cells 20A, 20B, and 20C (collectively referred to herein as solar cells 20). The photons in the sunlight are absorbed by one or more semiconducting material(s) (e.g., poly or mono crystalline silicon) in the solar cells. As photons are absorbed, electrons are excited from the valence band to the conduction band of the semiconductor. The electrons move via drift and diffusion causing current to flow through the semiconductive material and are extracted under bias to generate power.

An exemplary conventional silicon solar cell 20 is shown schematically in FIG. 1B. Solar cell 20 includes busbars 25 on the front major surface 21 of the semiconductor material forming the solar cell that interconnect and collect electrical charge from the conductive fingers 23 (FIG. 1B), wherein the conductive finger are aluminum fingers, copper fingers or silver fingers. Solar cell 20 includes a metalized layer or coating (typically aluminum) disposed on the rear major surface of the semiconductor material forming the solar cell forming the p-type side of the semiconductor junction. Because the metalized layer or coating on the rear major surface of the solar cell is generally porous and not solderable, solar cell 20 also has rear side busbars 26 (FIG. 1A) on the rear major surface 22 of the solar cell. Busbars 25, 26 are thin strips of a highly conductive metal (typically silver) that are solderable and can conduct the direct current produced by the solar cell(s). Soldering in conventional photovoltaic module assembly is carried out at temperatures of at least about 250° C.

Each single solar cell produces a limited amount of power, so solar cells are typically grouped together and sold as a photovoltaic module, such as photovoltaic module 10, shown in FIG. 1A. Photovoltaic module 10, which may also be referred to as a solar module, a photovoltaic module, a solar panel, or a photovoltaic panel, is a packaged, connected assembly comprising an array of solar cells.

In FIG. 1A, adjacent solar cells (first solar cell 20A and second solar cell 20B, and second solar cell 20B and third solar cell 20C) are connected by stringing ribbons 30. A portion (e.g., the end) of stringing ribbon 30 is soldered directly to busbar 25 on front major surface 21 of first solar cell 20A. A second portion (e.g., end) of stringing ribbon 30 is soldered to a busbar 26 on rear major surface of second solar cell 20B. Because the metalized coating on rear major surface of the solar cell 20 is not solderable, stringing ribbon 30 cannot be directly soldered to the rear major surface. In many conventional solar cells, solderable bus bars are formed by a screen printing process with a silver ink. Because silver can be quite expensive, the silver busbars represent a significant percentage of the total material cost for crystalline silicon solar cells. Reduction in solar module cost is one of the major targets for cost reduction and areas of solar-related technical innovation over the coming years.

Soldering of the stringing ribbons to the bus bars typically utilize tin-lead solders and high process temperatures (>250° C.) to electrically interconnect adjacent solar cells. Differences in the thermal expansion of the silicon, bus bars and stringing ribbons can induce stresses in the resulting soldered joints which could lead to premature failure in the photovoltaic module. Thus, a method of electrically connecting the solar cell in the photovoltaic modules at lower temperatures is needed. Additionally, reducing the amount of silver used on solar cells will reduce the cost of producing photovoltaic modules, making solar energy more cost competitive.

Metal foil pressure sensitive adhesive tapes have been proposed as a low temperature solder alternative for electrically connecting wires to solar cells surfaces. Pressure sensitive adhesives can be crosslinked after lamination to limit cold flow, but their inherent tackiness at ambient temperatures requires the use of release liners which may complicate their use and lead to excess waste. In addition, the fragility of solar cells limits rework during the module assembly process. Finally, the storage modulus of pressure sensitive adhesive, typically <0.1 MPa at temperatures greater than 40° C., may not be high enough to withstand the thermal cycling between −40° C. to 85° C. (the usable temperature range of solar cells).

Alternatively, tapes with electrically conductive adhesives have been proposed. Electrically conductive adhesives typically contain conductive particles, such as silver or other metal particles, at very high loadings (i. e. >70 weight percent) to ensure physical contact and good electrical conductivity. However, the conductive particles can be very expensive, and the high loading level limits the ability to adjust adhesive material properties. A low cost interconnect is needed for shingled design would also be advantageous to reduce stress enabling thinner cells.

Thus, there still remains a need for a simple, elegant, and low cost solution for low temperature electrical interconnection in photovoltaic module to replace high temperature soldering.

The present disclosure describes a polymer coated conductive ribbon that can be used to electrically interconnect adjacent solar cells at much lower temperatures (i.e., <200° C., preferably <180° C.) when compared to conventional soldering techniques that are carried out at (>250° C.), thus reducing thermal stresses on the silicon solar cells, which can enable production and adoption of thinner silicon solar cells. The exemplary polymer coated conductive ribbon described herein may simultaneously enable reduction or elimination silver busbars on the first and/or second major surfaces of the solar cells. The exemplary polymer coated conductive ribbon comprised a conductive ribbon substantially enclosed in an insulating polymeric sheath, wherein “substantially enclosed” means that the polymer sheath covers 85%, preferably greater than 90%, more preferably greater than 95% of the surface of the conductive member. In some embodiments, conductive ribbon may be completely enclosed in an insulating polymeric sheath.

More specifically, some embodiments of the present disclosure relate to polymer coated conductive ribbon for use in photovoltaic module to electrically interconnect solar cells, wherein the solar cell includes fine conductive fingers and optional busbars to collect electrical charge produced by the solar cell disposed on the front major surface of the semiconductor material forming the solar cell and a metalized layer or coating disposed on the rear major surface of the semiconductor material. The polymer coated conductive ribbon comprises a conductive member or ribbon enclosed in an insulating polymeric sheath capable of bonding to the first and second major surfaces the solar cell without soldering. In some embodiments, the polymer coated conductive ribbon may consist of a conductive member or ribbon enclosed in an insulating polymeric sheath capable of bonding to the first and second major surfaces the solar cell without soldering.

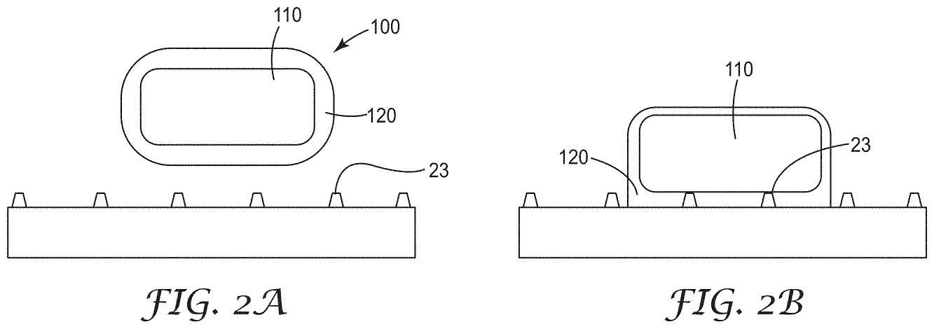

FIG. 2A shows a cross-sectional schematic diagram of an exemplary embodiment of a polymer coated conductive ribbon 100 that can be used in solar cell or photovoltaic module as described herein. In a first aspect, the polymer coated conductive ribbon comprised a conductive member 110 substantially enclosed in an insulating polymeric sheath 120, wherein “substantially enclosed” means that the polymer sheath covers greater than 85%, preferably greater than 90%, more preferably greater than 95% of the surface of the conductive member. In an exemplary aspect, insulating polymeric sheath is flowable under the lamination conditions used to fabricate the photovoltaic modulus (i.e., has a storage modulus of less than about 0.5 MPa, preferably less than 0.2 MPa, at 160° C., more preferably 0.05 MPa, at 160° C. as measured by a rheometer with a parallel plate fixture as described below). In some aspects of the invention, the insulating polymer sheath completely covers the circumferential surface of the conductive member.

In some aspects of the invention, the material making up the polymeric sheath may be uncrosslinked. Polymeric sheath 120 is flowable, enabling direct contact of the conductive member with the conductive fingers/busbars on the front surface of the solar cell and the metallized rear surface of the solar cell 20.

Applying polymer coated conductive ribbon 100 with heat and pressure causes the material of the insulating polymeric sheath 120 to melt and flow, allowing the material to flow out of the contact region between the busbars/conductive fingers on the front side of the solar cell or the porous metallized rear surface of the solar cell and conductive member 110 of the polymer coated conductive ribbon. On the front side of the solar cell the material from the polymer sheath will flow around the busbars/conductive finger and onto the front surface of the solar cell forming a mechanical bond between the polymer coated conductive ribbon and the frontside of the solar cell. On the rear side of the solar cell, the melt viscosity of the material making up the polymer sheath should be low enough so that it can flow into the pores in the porous metallized surface to form a strong mechanical connection upon cooling. Additionally, the conductive member may conform to the surface of and make electrical contact with porous conductive aluminum material 400 while being locked into place by the material of the polymer sheath.

In general, conductive member 110 is a smooth conductive ribbon having a defined width and thickness, such that the conductive member has a cross section area less than 0.5 mm², preferably less than 0.3 mm². “Smooth” means a condition with an untextured and smooth appearance to the naked eye, and specifically a condition wherein the average roughness of the conductive member surface is no greater than 20 microns, preferably no greater than 10 microns. The cross-section of the conductive ribbon may be rectangular or elliptical. The conductive member may comprise a strip of metal foil. Exemplary metal foil materials include, for example, copper, aluminum, tin, iron, nickel, silver, gold, lead, zinc, cobalt, chromium, titanium, and the like. In some embodiments, the polymer coated conductive ribbon can include a metal foil strip having multiple metallic layers. In an alternative embodiment, the polymer coated conductive ribbon can include a metal foil strip surrounded by an additional conductive layer or thin protective layer, such as an oxidation protection layer or a corrosion protection layer. In a second aspect, the polymer coated conductive ribbon consists of a conductive member substantially enclosed in an insulating polymeric sheath 120. In an exemplary aspect, insulating polymeric sheath is flowable under the lamination conditions used to fabricate the photovoltaic modulus (i.e., has a storage modulus of less than about 0.5 MPa, preferably less than 0.2 MPa, at 160° C., more preferably 0.05 MPa, at 160° C.) prior to application to the solar cell, wherein “substantially enclosed” has the meaning defined above. In some aspects of the invention, the insulating polymer sheath completely covers the circumferential surface of the conductive member.

To facilitate handling and storage it is desirable to package the polymer coated conductive ribbon in spools like wire. Thus, the polymer coated conductive ribbon should not be tacky or sticky at typical storage and handling conditions, but the insulating polymer material of the polymer sheath should be able to flow when subjected to elevated temperatures between 120° C. and 180° C.

The insulating polymer layer does not contain any conductive particles. Electrical conductivity is achieved by direct contact of the copper ribbon to the conductive fingers/busbars on the front surface of the solar cell and the metallized or screen printed rear busbars on the rear surface of the solar cell.

Any metal foil may be used as the conductive member in the polymer coated conductive ribbon of the present disclosure. Exemplary metal foil materials include, for example, copper, aluminum, tin, iron, nickel, silver, gold, lead, zinc, cobalt, chromium, titanium, and the like. In a preferred aspect, the conductive member can be a strip of copper foil. In certain embodiments, the metal foil comprises a passivated Electro-Deposited (ED) High Temperature Elongation (HTE) Copper foil. In some aspects, the conductive member may be coated with an alloy having a melt temperature that is less than about 185° C. In other embodiments, the metal foil comprises a protective layer or an adhesion promotion layer to keep the foil from corroding or oxidizing. Exemplary protective layers may comprise zinc, tin, silver, gold, or the like. Exemplary adhesion promotion layers may comprise a chromium/zinc alloy, tin/bismuth/silver alloy, tin/lead alloys, tin/bismuth alloys, bismuth/indium alloys, tin/indium alloys, and the like.

The metal foil or metal foil layers in a multilayer conductive ribbon may be of any desired thickness. Some embodiments have a metal foil layer thickness that is between about 15 microns and about 350 microns. In some embodiments, the metal foil thickness is any thickness that does not cause an unacceptable level of bowing or warping of the solar cell. Some embodiments of the polymer coated conductive ribbons and solar cells described herein exhibit bowing or warping of less than 3 mm. Some embodiments of the polymer coated conductive ribbon and solar cells described herein exhibit bowing or warping of less than 2 mm. Some embodiments of the polymer coated conductive ribbons and solar cells described herein exhibit bowing or warping of less than 1.5 mm.

The conductive ribbon 110 may have any desired electrical conductivity. Some embodiments have a conductive ribbon electrical conductivity that is greater than 5×10⁷ S/m at 23° C. Some embodiments have a conductive ribbon electrical conductivity that is greater than 1×10⁶ S/m at 20° C.

The exemplary nonconductive polymer sheath 120 surrounds the conductive ribbon of the polymer coated conductive ribbon of the present disclosure and comprises a nonconductive polymer material. In some embodiments, the polymer sheath can be transparent or substantially transparent in the wavelength range of about 350 nm to about 1100 nm. The nonconductive polymer material should be selected to provide sufficient mechanical performance over the accepted operating temperatures of the photovoltaic module, i.e. −40° C. to 85° C.

The nonconductive polymer sheath should be non-tacky (i.e., having a storage modulus (G′) greater than 0.2 MPA at 40° C.) to facilitate storage and handling (i.e., so the polymer coated conductive ribbon can be spooled without requiring a release liner to prevent sticking).

In some aspects, the polymer sheath can have a thickness that is about the same height as the busbars or conductive fingers of the solar cells to which it will be bonded to optimize the bond strength. The polymer material making up the polymer sheath should bond strongly to the silicon nitride (SiNx) passivation layer on the surface of silicon solar cells, indium tin oxide (ITO) of heterojunction solar cells as well as the conductive materials of the conductive member of the polymer coated ribbon (e.g., copper foil) and the conductive materials on the surface of the solar cells, such as the conductive fingers and busbars (e.g., silver) or the metallized back surface (e.g., aluminum) or screen printed conductive fingers on the back surface of bifacial solar cells.

The polymer sheath can have a thickness between about 5 μm and about 75 μm, preferably about 15 μm and about 60 μm. Some embodiments have a nonconductive polymer sheath having a thickness between about 5 microns and about 50 microns. Some embodiments have a nonconductive polymer sheath layer thickness that is between about 5 microns and about 30 microns. Some embodiments have a nonconductive polymer having a thickness between about 5 microns and about 20 microns. In some embodiments, the nonconductive polymer sheath has a thickness of about 5 microns, 6 microns, 7 microns, 8 microns, 9 microns, 10 microns, 11 microns, 12 microns, 13 microns, 14 microns, 15 microns, 16 microns, 17 microns, 18 microns, 19 microns, 20 microns, 21 microns, 22 microns, 23 microns, 24 microns, 25 microns, or 26 microns.

The polymer sheath may be symmetrically disposed around the conductive member or may be asymmetrically disposed around the conductive member. For example, the thickness of the polymer sheath on one of the major surfaces of the conductive member may be thicker than the polymer sheath on the other major surface of the conductive member. Alternatively, the thickness of the polymer sheath on the major surfaces of the conductive member may be thicker than the polymer sheath on the side surfaces of the conductive member.

In some embodiments, the nonconductive polymer material is a thermoplastic insulating polymer. Exemplary thermoplastic insulating polymers can comprise a polyolefin copolymer with polar monomers (e.g., (meth)acrylic acid, maleic anhydride, alkyl (meth)acrylates), a phenoxy resin, a polyurethane, a polyesters, a poly(meth)acrylate, a polyamides, and fluoropolymers made from the monomers tetrafluoroethylene, polyvinylidene difluoride, and hexafluoropropylene. In a preferable aspect, thermoplastic insulating polymers can be a ethylene-maleic anhydride copolymer, a propylene-maleic anhydride copolymer, an ethylene-methacrylic acid copolymer, a phenoxy resin, a polyamide, a polymethacrylate, or a polyurethane, more preferably an ethylene-methacrylic acid copolymer, a phenoxy resin, a polyamide, or a polyurethane.

In some aspects of the invention, the nonconductive polymer material can be a linear polymer that will flow around 160° C.-180° C., preferably around 120° C.-140° C. around the bus bars or finger areas or into the pores of the metalized back surface of the solar cell. By using nonconductive polymer material having this flow profile, the polymer coated conductive ribbon may provide a “Self-healing” solution. If residual insulating polymer is present in between the ribbon and bus bar, the localized temperature will increase due to increased electric current resistance. When temperature is above the melting point of the polymer, the liner polymer will melt and flow away, reducing the amount of insulating polymer between the ribbon and busbars/fingers, improving contact and conductivity and eliminating hot spots.

In a first aspect of the invention, the nonconductive polymer material of the polymer sheath can be a nontacky, amorphous material having a glass transition temperature of at least 40° C., preferably greater than 60° C. as determined by differential scanning calorimetry with a 10° C./min heating rate.

In some aspects, the nonconductive polymer material may be a semicrystalline material having a melt point of at least 85° C., preferably at least 100° C., more preferably at least 120° C.

The modulus polymer can be selected to generate the minimal stresses during module assembly and to hold the conductive member of the polymer coated conductive ribbon the surface to which it is bonded, e.g., conductive fingers and bus bars, under thermal cycling at standard operating temperatures.

Additionally, the thermoplastic polymer has a rheology that allows it to penetrate at least some of the pores in the metalized layer on the rear surface of the solar cell during bonding conditions that are greater than ambient heat and pressure. For example, the thermoplastic insulating polymer as a first storage modulus (G′) is above 0.2 MPa at 80° C. and a second storage modulus below 0.05 MPa at 160° C. When the nonconductive polymer material enters the pores, it enables the conductive metal foil to establish permanent electrical contact with the bottom major surface of the solar cell.

In some embodiments, additives may be added to the insulating polymer in the polymer sheath. Exemplary additives may include antioxidants, corrosion inhibitors, such as benzotriazole; adhesion promoters, such as silane coupling agents. In some embodiments, the polymer sheath can further comprise a corrosion inhibitor.

In certain embodiments, polymer coated conductive ribbon is sufficiently flexible to conform to the fine silver gridlines on the front side of a solar cell when bonded under pressure or under hot-pressing conditions. In other embodiments, the polymer coated conductive ribbon is capable of adhering to crystal-silicon photovoltaic material, as well as the fine silver gridlines and/or the silver busbars on the front side of a solar cell and make an electrical connection with those silver gridlines and/or silver busbars.

The exemplary polymer coated conductive ribbon 100 is configured for use on either the front major surface or the rear major surface of the solar cell. The polymer coated conductive ribbons described herein can be heat bonded/hot pressed at temperatures below 180° C. to the rear surface of the solar cell or over the conductive fingers on the front surface of the solar cell using any known method. During this process, the insulating polymer material forming the polymer sheath flows out from between the conductive member and around the surface to which it is being applied to bind the conductive member to the solar cell.

In some embodiments, the polymer coated conductive ribbon can be generally aligned with one or more of the front side busbars in solar cell having conductive busbars. The alignment of polymer coated conductive ribbons can be attached to the front side of one solar cell and the back side of an adjacent solar cells to act as a stringing ribbon between adjacent cells. As used herein, the term “hot pressed” or “hot pressing” refers to a method of heating the polymer sheath to a temperature greater than about 100° C. and simultaneously applying a pressure of greater than about 0.2 MPa to create a reliable bond between the polymer coated conductive ribbons and the solar cells to which it is attached. Exemplary methods of hot pressing include, for example, hot bar bonding, hot platen-pressing, hot roll-to-roll lamination, hot vacuum lamination, and the like.

In other embodiments, the polymer coated conductive ribbon 100 can be applied to solar cell 20 across a plurality of conductive fingers 23 by hot pressing in order to collect the electrical current is collected by fine silver fingers as shown in FIGS. 2A and 2B. During the step of hot pressing, the storage modulus of polymer material in the insulating polymer sheath 120 are reduced allowing the polymer material to flow around the conductive fingers enabling the conductive fingers to make mechanical and electrical contact with the central conductive member 110 in the polymer coated conductive ribbon. After the heat is removed, the material which was originally the polymer sheath can solidify to hold the conductive member to the conductive fingers or busbars and/or the surface of the solar cell.

Some embodiments of the photovoltaic modules, solar cells, and/or polymer coated conductive ribbons of the present disclosure endure one or both of at least 200 cycles of thermal cycling (−40° C. to 85° C.) and damp heat (85° C./85% Relative Humidity testing) for at least 1000 hours with less than 5% decrease in fill factor of the solar cell. Some embodiments of the photovoltaic modules, solar cells, and/or polymer coated conductive ribbons of the present disclosure endure one or both of 400 thermal cycles (−40° C. to 85° C.) and damp heat (85° C./85% Relative Humidity testing) for at least 2000 hours with less than 5% decrease in fill factor of the solar cell. Some embodiments of the photovoltaic modules, solar cells, and/or polymer coated conductive ribbons of the present disclosure endure one or both of 600 thermal cycles (−40° C. to 85° C.) and damp heat (85° C./85% Relative Humidity testing) for at least 3000 hours with less than 5% decrease in fill factor of the solar cell. In one embodiment, the photovoltaic modules, solar cells, and/or polymer coated conductive ribbons of the present disclosure do not contain conductive particles.

In an alternative aspect, polymer coated conductive ribbon can be used to fabricate shingled cell photovoltaic modules. In order to produce shingled photovoltaic modules, silicon solar cells are cut into strips and overlapped inside of a framed module in order to remove intercellular gaps between adjacent solar cells providing more active surface area in the shingled photovoltaic module compared to a conventional photovoltaic module. Increasing the active cell area should improve power output and module efficiency of the shingled photovoltaic module over that produced by a conventional photovoltaic module. The conventional silicon solar cells are laser sliced along the busbars and interconnected by positioning the rear busbar of one slice over the front busbar of the next slice and electrically and mechanically connecting the adjacent slices together with a conductive adhesive. Thus, the busbars are hidden in the overlap of the adjacent sliced cells, eliminating the need for interconnection ribbons and gaps between adjacent cells. Positioning the busbars in the overlap region of adjacent cells further increases the active silicon surface in the module.

However, the shingled photovoltaic modules have challenges which still need to be overcome. Since the electrical and mechanical interconnection between adjacent slices is formed by physical contact of the sliced cells, the varying thermal expansion coefficients of silicon, silver and glass will create different levels of thermo-mechanical stress on the interconnection. Therefore, the interconnection should be flexible, and the use of conductive adhesives is favored over soldered connections, but conductive adhesives are expensive, require specialized tooling (e.g., adhesive dispensing equipment and fixturing) and may limit production throughput.

Additionally, electrically conductive adhesives typically comprise high loadings, typically greater than about 70 weight percent, of metal particles, e.g., silver particles or flakes, in order to provide sufficient electrical conductivity between adjacent solar cell slices. The high cost of the metal particles and the high loading levels in the electrically conductive adhesives can limit the adhesive properties of the electrically conductive adhesive.

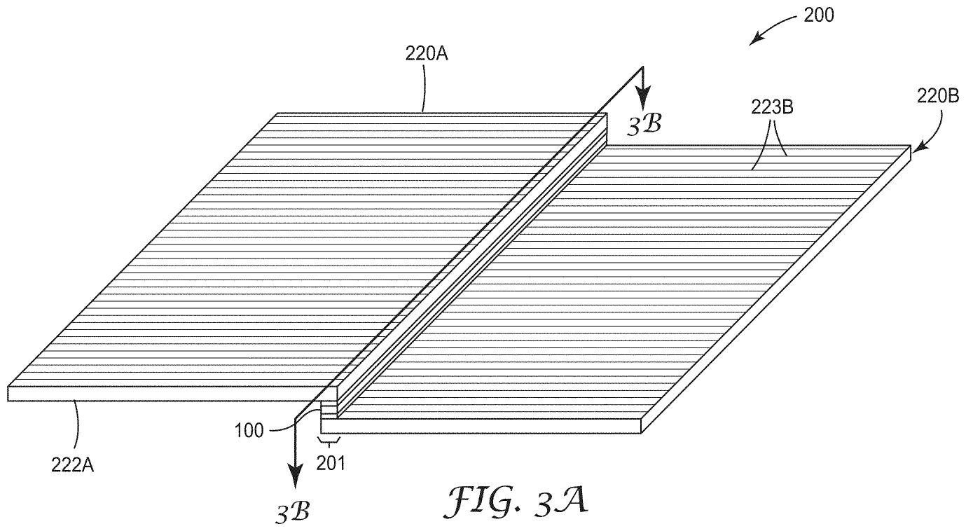

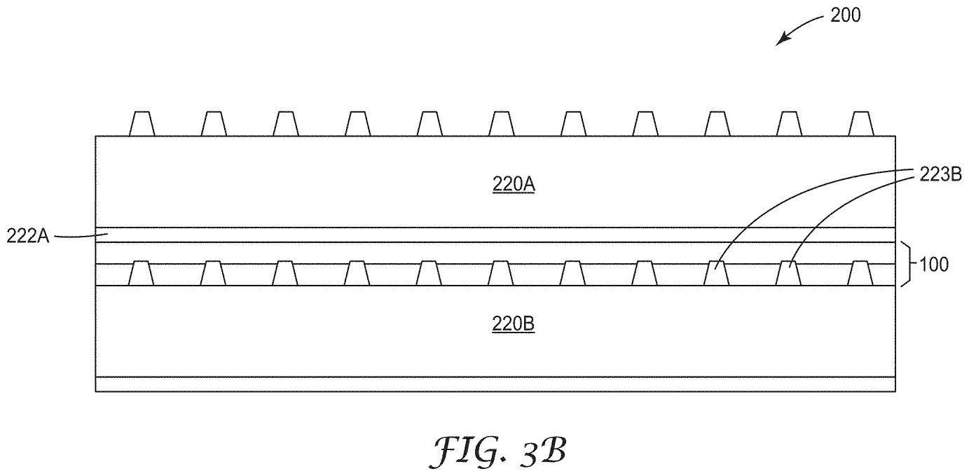

FIG. 3A is a schematic illustration of a shingled cell array unit wherein two adjacent cell slices 220A, 220B are electrically interconnected by polymer coated conductive ribbon 100. FIG. 3B is a schematic cross-section of the connection region between the two adjacent cell slices of FIG. 3A. In the exemplary embodiment shown in FIGS. 2A and 2B, no bus bars or conductive adhesives are required to make the electrical connection between adjacent cell slices 220A, 220B yielding a thinner, lower profile shingled cell array. Polymer coated conductive ribbon 100 electrically connects the metallized rear surface 222A to the conductive fingers 223B on the front side of cell slice 220B. Controlling the melt rheology of the polymer material in the polymer sheath enables direct connection of the metallized rear surface 222A to the conductive fingers 223B to the conductive member 110 of polymer coated conductive ribbon 100 after bonding.

The photovoltaic modules, solar cells, and polymer coated conductive ribbons of the present disclosure have many advantages and benefits. Some of these advantages and benefits are described below. Some embodiments of the photovoltaic modules, solar cells, and polymer coated conductive ribbons have reduced residual stresses due to the elimination of high temperature soldering processes. Some embodiments of the photovoltaic modules, solar cells, and polymer coated conductive ribbons described herein can maintain function even when subjected to environmental conditions such as damp heat and thermal cycling.

### EXAMPLES

### Test Methods

### Photovoltaic Module Testing (Flash Test)

Photovoltaic module testing on PV modules was done on a Spi-Sun Simulator 3500 SLP Photovoltaic Module Tester manufactured by Spire Corp., in Bedford, Mass. The simulator will flash the module with calibrated lamps and measure the voltage/current response. The software for this photovoltaic module tester then calculates various values for parameters from the current-voltage curve such as fill factor (FF), open circuit voltage (Voc), short circuit current (Isc), maximum power (Pmax), shunt resistance (Rs), and efficiency. After initial module testing with the photovoltaic module tester, the prototype test PV modules were placed in environmental chambers and periodically removed for repeat module testing. The data for the fill factor of the sample materials tested are provided in Table 2.

### Thermal Analysis of Polymer Materials

Differential scanning calorimetry analysis of polymeric materials were conducted using a TA Instruments Q2000 instrument. Sample specimens were characterized using 10° C./min heating ramps from −60° C. to 250° C.

### Rheological Analysis of Polymer Materials

The rheological analysis of polymeric materials was conducted using a TA Instruments Discovery HR-3 instrument with an 8 mm parallel plate fixture. Sample specimens were characterized under 100 g±15% axial force control, 1% strain, 1 Hz oscillation and 3° C./min heating ramps from 40° C. to 200° C., unless specified otherwise.

Thermal Cycle with Bias Test

Photovoltaic modules are placed in an environmental chamber that is cycled between −40° C. and 85° C., in accordance with Thermal Cycle Test standard IEC61215-2.(IEC2021). An EnviroFLX500 environmental chamber from Weiss Envirotronics, Grand Rapids, Mich. was used. The temperature control of the chamber was calibrated and controls the appropriate rate of temp change and meet minimum temperature requirements. The cycle was timed such that 5 cycles were complete in each day and samples removed for flash testing at 50 or 100 cycle increments. The individual single cell module test cells had a bias current of 9 A DC that is applied to the module during the heating cycle only using an E3633A Power Supply from Agilent Technologies Inc, Santa Clara Calif.

Materials

| DESIGNATION | DESCRIPTION | SOURCE |
|---|---|---|
| pEMA | Nucrel 0407HS poly(ethylene-co- | Dow Inc. |
| | methacrylic acid) | |
| pEAA | Nucrel 3990 ethylene-acrylic acid | Dow Inc. |
| | copolymer | |
| 2EHA | 2-Hydroxyethyl Acrylate | Sigma-Aldrich |
| AA | Acrylic Acid | Alfa Aesar |
| V-67 | 2,2′-Azobis(2-methylpropionitrile) | Sigma-Aldrich |
| EtOAc | Ethyl Acetate | Sigma-Aldrich |
| Si solar cell | 4BB Solar Cell | Sino-American |
| | | Silicon Products |
| | | Inc. |
| Conductive | 200 μm thick PV Ribbon is a 2 mm | Ulbrich Specialty |
| member | wide copper ribbon coated with | Wire Products |
| | 62/36/2 Tin/Lead/Silver solder | |

### EXAMPLES

### Comparative Example 1—Pressure Sensitive Adhesive Coated Conductive Ribbon

A solution pressure sensitive adhesive (PSA) was synthesized using a method adapted from a prior publication (WO 2020/240337). Specifically, 2EHA (450 g) and AA (50 g) were added to a 2 L stainless steel Buchi reactor. Ethyl acetate (375 g) and methanol (125 g) were added to the reactor. The reactor was heated up to 55° C. with an agitation speed of 150 rpm. After that, 2,2′-azobis-(2-methylbutyrnitrile) initiator (0.5 g) was added to the solution. The reaction was started by pinging the solution with nitrogen several times to remove all oxygen. The reaction was stirred at 150 rpm at 55° C. for 12 hours and then at 65° C. for 5.25 hours. After the reaction is complete, ethyl acetate (442 g) and methanol (225 g) were added to the reactor to dilute the solution, and PSA solution was coated onto a release liner to 1.5 mil final thickness. The PSA film (1.5 mil thick) was cut to 150 mm length and transferred onto 200 mm long, 2 mm wide, 0.2 mm thick pieces of the conductive member at 25° C. and with a rubber roller. PSA coated foil were trimmed to remove excess polymer coating around the tabbing ribbons and stored until further converting.

### Comparative Example 2—Soldered Ribbons

200 mm long, 2 mm wide, 0.2 mm thick PV ribbons from Ulbrich Specialty Wire Products (Westminster, S.C.) were soldered to the busbars on both the front and back of 4BB solar cells at 450° C. The front and the back tabbing ribbons were then soldered respectively to 5 mm wide, 0.3 mm thick busbars as electrical leads for flash testing. Comparative example 2 was found to have a fill factor of 0.749.

### Example 1—pEMA Film Coated Conductive Ribbon

A pEMA film was prepared extruding the pEMA resin with typical single screw extruder equipped with a film die onto a polyester carrier film to yield a 12 inch wide pEMA film. The Film target was 25 μm thick and temperatures ramped from 185 to 215° C. through the screw and extrusion die. The resulting pEMA film was easily peeled off the PET after it cooled.

The pEMA film was transferred onto 200 mm long, 2 mm wide, 0.2 mm thick pieces of conductive member using a hot press. The coating length was set to 150 mm. The hot press was set to 110° C. and the lamination process was conducted under 3 ton force for 3 minutes. pEMA coated ribbon was trimmed to remove excess polymer coating around the tabbing ribbons and stored until further converting.

### Example 2—pEAA Film Coated Conductive Ribbon

A pEAA film was prepared extruding the pEAA resin with typical single screw extruder equipped with a film die onto a polyester carrier film to yield a 12 inch wide pEAA film. The Film target was 25 μm thick and temperatures ramped from 185 to 215° C. through the screw and extrusion die. The resulting pEAA film was easily peeled off the PET after it cooled.

The pEAA film was transferred onto 200 mm long, 2 mm wide, 0.2 mm thick pieces of conductive member using a hot press. The coating length was set to 150 mm. The hot press was set to 110° C. and the lamination process was conducted under 3 ton force for 3 minutes. pEAA coated ribbon was trimmed to remove excess polymer coating around the tabbing ribbons and stored until further converting.

Exemplary thermal properties and the storage modulus for the insulating polymers coated on the conductive member are provided in Table 1.

TABLE 1
Thermal properties of a selection of exemplary materials

| | | | Storage | Storage | |
|---|---|---|---|---|---|
| | | | modulus | modulus | |
| | T_{g} | Tₘ | (MPa @ | (MPa @ | |
| Material | (° C.) | (° C.) | 40° C.) | 160° C.) | Comments |
| Comparative | −37 | N/A | 0.04 | 0.01 | Tacky at |
| example 1 | | | | | 25° C. |
| Example 1 | Not detected | 110 | 53.1 | 0.03 | Non-tacky |
| | above −50 | | | | |

### Application of Polymer Coated Ribbons to a Solar Cell

The polymer coated conductive ribbons were applied to the frontside of the 4BB Si solar cells available from Sino-American Silicon Products Inc (Hsinchu Science Park, Taiwan) in the gap between the busbars with the middle ribbon placed on top of the conductive fingers, and with the exterior ribbons placed towards the outside edges of the solar cells but still between the busbars. The polymer coated conductive ribbons were bonded to the solar cell with a hot bar bonder built by Komax Solar (now Xcell Automation, York, Pa.), and a sheet of release liner (4400L PET release liner available from Loparex LLC, Hammond Wis.) was placed between the busbar tape and the metal hot bar element. The solar cell was placed on top of a heated nest, and the polymer coated conductive ribbons were manually placed on the solar cell in the positions described above. The release liner was placed on top of the solar cell and ribbons with the release coating facing the ribbons, and the bonder was activated to press the heater bars on top of the polymer coated conductive ribbons and the solar cell. The polymer coated conductive ribbons were placed such that they are aligned underneath the heater bars during the bonding process. The process variables that were controlled are bonding time, nest temperature, heater bar temperature, and heater bar applied pressure. The conditions for each of the examples are listed in Table 2.

TABLE 2
Conditions for applying exemplary polymer
coated ribbons to a solar cell

| | | Stage 1 | | | |
|---|---|---|---|---|---|
| | Nest Heater | Heater bar | Stage 1 | Pres- | |
| | temperature | temperature | time | sure | Fill |
| Sample | (° C.) | (° C.) | (minutes) | (PSI) | Factor |
| Example 1 | 120 | 160 | 15 | 65 | 0.734 |
| Comparative | 100 | 100 | 2 | 65 | Not |
| example 1 | | | | | applicable |

### Durability Testing of Solar Cell

Example solar cells were removed from cycling at intervals 100, 200, and 300 cycles to compare typical performance results Pmax and Fill Factor. The results are given in Table 3 as measured by the flash test.

TABLE 3
Performance data after Thermal Cycle with Bias
Testing (IEC61215-2) at 9 A bias current.

| | Cycles | Pmax | FF |
|---|---|---|---|
| Comparative | 0 | 4.385 | 0.749 |
| example 2 | 100 | 4.331 | 0.738 |
| | 200 | 4.430 | 0.754 |
| | 300 | 4.259 | 0.723 |
| Example 2 | 0 | 4.411 | 0.750 |
| | 100 | 4.346 | 0.741 |
| | 200 | 4.409 | 0.752 |
| | 300 | 4.291 | 0.732 |

In accordance with Table 3, Example 2 is at least as effective as the solder-based comparative Example 2 in terms of thermal cycle with bias.

Various modifications, equivalent processes, as well as numerous structures to which the present invention may be applicable will be readily apparent to those of skill in the art to which the present invention is directed upon review of the present specification.

What is claimed is:

1. A polymer coated conductive ribbon consists essentially of a smooth conductive member, having a defined width and thickness, substantially enclosed in an insulating polymeric sheath, wherein the insulating polymeric sheath comprises a thermoplastic insulating polymer as a first storage modulus (G′) is above 0.2 MPa at 40° C. and a second storage modulus below 0.05 MPa at 160° C.

2. The conductive ribbon of claim 1, wherein the thermoplastic insulating polymer comprises a polyurethane, polyolefin (co)polymer with a polar monomer, phenoxy resin, polyester, polyamide, and fluoropolymers made from the monomers tetrafluoroethylene, polyvinylidene difluoride, and hexafluoropropylene.

3. The conductive ribbon of claim 1, wherein the thermoplastic insulating polymer is a polyolefin copolymer with polar monomers and wherein the polyolefin copolymer with polar monomers is an ethylene-methacrylic acid copolymer.

4. The conductive ribbon of claim 1, wherein an exposed surface of the polymer sheath is non-tacky at room temperature.

5. The conductive ribbon of claim 1, wherein the polymer sheath comprises an amorphous polymer has a glass transition temperature of at least 40° C., as determined by dynamic scanning calorimetry.

6. The conductive ribbon of claim 1, wherein the polymer sheath comprises a semicrystalline polymer having a melting point of at least 80° C.

7. The conductive ribbon of claim 1, wherein the conductive member has a cross section area less than 0.5 mm².

8. The conductive ribbon of claim 1, wherein the conductive member comprises a copper strip.

9. The conductive ribbon of claim 8, wherein the polymer sheath further comprises a corrosion inhibitor.

10. The conductive ribbon of claim 9, wherein the copper strip is coated with an alloy having a melt temperature that is less than about 185° C.

11. The conductive ribbon of claim 8, wherein the low temperature material comprises a chromium/zinc alloy, tin/bismuth/silver alloy, tin/lead alloy, tin/bismuth alloys bismuth/indium alloys, or tin/indium alloys.

12. A photovoltaic solar module, comprising:
a plurality of solar cells disposed in an ordered array, wherein each solar cell comprises a silicon wafer having at least one first electrically conductive element formed on a front surface of the solar cell and at least one second electrically conductive element formed on a back surface of the solar cell; and
at least one polymer coated conductive ribbon of claim 1, electrically interconnecting at least one first electrically conductive element or second electrically conductive element of a first solar cell to at least one first electrically conductive element or second electrically conductive element of a second solar cell without the use of solder.

13. The photovoltaic solar module of claim 12, wherein the first conductive element is one of a busbar or conductive silver fingers formed on the front surface of the solar cell.

14. A photovoltaic solar module of claim 12, wherein the second conductive element is one of a busbar, conductive fingers or a metallized coating on the back surface of the solar cell.

15. The photovoltaic solar module of claim 12, wherein the photovoltaic module is a shingled cell voltaic module wherein the shingled cell module comprises at least a first solar cell and a second cell disposed in a partially overlapping configuration defining an overlap region wherein the polymer coated conductive ribbon is disposed in the overlap region to electrically connect the at least one first electrically conductive element formed on a front surface of the first solar cell to the at least one second electrically conductive element formed on a back surface of the second solar cell.
